(19) United States
(12) Patent Application Publication
(10) Pub. No.: US 2009/0103446 A1
(43) Pub. Date: Apr. 23, 2009

(54) APPARATUS AND METHOD FOR ESTIMATING NOISE AND INTERFERENCE ON RANGING CHANNEL IN A BROADBAND WIRELESS COMMUNICATION SYSTEM

(75) Inventors: Ha-Young YANG, Yongin-si (KR); Sung-Kwon JO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/253,601

(22) Filed: Oct. 17, 2008

(30) Foreign Application Priority Data
Oct. 22, 2007 (KR) 10-2007-0105909

(51) Int. Cl. H04L 12/26

(52) U.S. Cl. 370/252

(57) ABSTRACT

An apparatus and a method for estimating a noise/interference power value of a ranging channel in a broadband wireless communication system are provided. An apparatus for a base station in a broadband wireless communication system includes an operator, an estimator, and an adder/subtractor. The operator calculates the receive (RX) power of a ranging subcarrier signal received through ranging subcarriers. The estimator estimates the signal power of a detected ranging signal. The adder/subtractor calculates the noise/interference power of a ranging channel by subtracting the signal power of the detected ranging signal from the RX power of the ranging subcarrier signal.

### PRIORITY

This application claims the benefit under 35 U.S.C. §119(a) of a Korean patent application filed in the Korean Intellectual Property Office on Oct. 22, 2007 and assigned Serial No. 2007-105909, the entire disclosure of which is hereby incorporated by reference.

### BACKGROUND OF THE INVENTION

1. Field of the Invention

The present invention relates to broadband wireless communication systems. More particularly, the present invention relates to an apparatus and method for estimating noise and interference on a ranging channel in a broadband wireless communication system.

2. Description of the Related Art

Extensive research is being conducted to provide various Quality of Service (QoS) features with a data rate of about 100 Mbps in the advanced fourth-generation (4G) communication system. The 4G communication system is evolving to provide mobility, high data rate transmission, and high QoS in a Broadband Wireless Access (BWA) communication system such as a Local Area Network (LAN) system and a Metropolitan Area Network (MAN) system. A typical example of the above system is identified in the Institute of Electrical and Electronics Engineers (IEEE) 802.16 communication system. The IEEE 802.16 communication system uses an Orthogonal Frequency Division Multiplexing (OFDM)/Orthogonal Frequency Division Multiple Access (OFDMA) scheme in order to support a broadband transmission network in a physical channel of the wireless communication system.

A ranging process is defined in the IEEE 802.16 communication system. The ranging process is provided to support a random access of a user terminal using a preset ranging code. The ranging can be divided into initial ranging, periodic ranging, bandwidth request ranging, and handover ranging. In particular, the initial ranging and the periodic ranging are used to detect a user terminal that is attempting to access the communication network, to estimate propagation delay parameters for acquisition of frame synchronization, and to estimate a Noise and Interference (NI) and a Signal-to-Interference and Noise Ratio (SINR) used for power control.

According to the standards of the IEEE 802.16 communication system, a base station must broadcast UpLink Noise and Interference (UL NI) information to user terminals. The UL NI is measured in dBm and is broadcast through an Information Element (IE) called an ‘UL NI level’. If there is an error in the UL NI estimation, the base station fails to control power adequately. Accordingly, signal transmission/reception in a cell fails and interference with an adjacent cell occurs, thereby degrading the system performance.

For estimation of a UL NI of a signal used in the periodic ranging, the base station must estimate a UL NI without the use a known signal such as a pilot signal. Thus, the estimation of the UL NI of the signal used in the periodic ranging has a high error probability in comparison with coherent detection. Also, due to the characteristics of ranging, a plurality of user terminals may transmit a ranging code simultaneously through the same resource region. Such a ranging code collision makes the estimation of a UL NI of a periodic ranging channel more difficult. What is therefore required is an alternative scheme for accurately estimating the UL NI of the periodic ranging channel, in order to prevent the degradation of system performance.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for estimating an UpLink Noise and Interference (UL NI) on a ranging channel in a broadband wireless communication system.

Another aspect of the present invention is to provide an apparatus and method for estimating a UL NI in a broadband wireless communication system by using a correlation between ranging signals.

According to an aspect of the present invention, an apparatus for a base station in a broadband wireless communication system is provided. The apparatus includes an operator for calculating the receive (RX) power of a ranging subcarrier signal received through ranging subcarriers, an estimator for estimating the signal power of a detected ranging signal and an adder/subtractor for calculating the noise/interference power of a ranging channel by subtracting the signal power of the detected ranging signal from the RX power of the ranging subcarrier signal.

According to another aspect of the present invention, a method for estimating a ranging channel noise/interference power value of a base station in a broadband wireless communication system is provided. The method includes calculating the receive (RX) power of a ranging subcarrier signal received through ranging subcarriers, estimating the signal power of a detected ranging signal and calculating the noise/interference power of a ranging channel by subtracting the signal power of the detected ranging signal from the RX power of the ranging subcarrier signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings in which:

FIG. 1 is a diagram illustrating a structure of a ranging code in a broadband wireless communication system according to an exemplary embodiment of the present invention;

FIG. 2 is a block diagram of a base station in a broadband wireless communication system according to an exemplary embodiment of the present invention;

FIG. 3 is a block diagram of a ranging NI estimator in a broadband wireless communication system according to an exemplary embodiment of the present invention;

FIG. 4 is a block diagram of a ranging NI estimator in a broadband wireless communication system according to an exemplary embodiment of the present invention;

FIG. 5 is a flow diagram illustrating a process for estimating a UL NI of a base station in a broadband wireless communication system according to an exemplary embodiment of the present invention; and

FIG. 6 is a flow diagram illustrating a process for estimating a UL NI of a base station in a broadband wireless communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, well-known functions and constructions are omitted for clarity and conciseness.

Exemplary embodiments of the present invention provide a scheme for estimating an UpLink Noise and Interference (UL NI) of a ranging channel. The following description is made in the context of an Orthogonal Frequency Division Multiplexing (OFDM) wireless communication system, to which the present invention is not limited. Thus, it should be clearly understood that the present invention is also applicable to any other wireless communication system. Also, the following description is made on the assumption that a base station is based on a Multiple-Input Multiple-Output (MIMO) technique using two receive (RX) antennas, to which the present invention is not limited. Thus, it should be clearly understood that the present invention is also applicable to any other base station that is not based on the MIMO technique or uses three or more RX antennas.

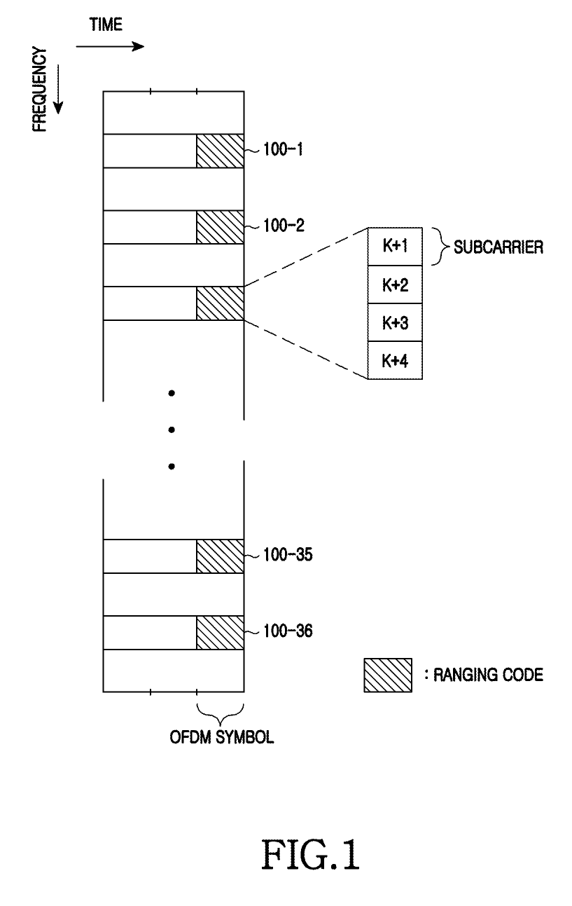

FIG. 1 is a diagram illustrating a structure of a ranging code in a broadband wireless communication system according to an exemplary embodiment of the present invention. The following description is made on the assumption of using a ranging code with a structure illustrated in FIG. 1.

Referring to FIG. 1, four subcarriers, consecutive on the frequency axis, constitute one tile, and a ranging code occupies 36 tiles 100-1 to 100-36, i.e., 144 tones. More specifically, four subcarriers on the frequency axis and three OFDM symbols on the time axis constitute one tile, and the ranging code is transmitted/received through the third OFDM symbol in the tile.

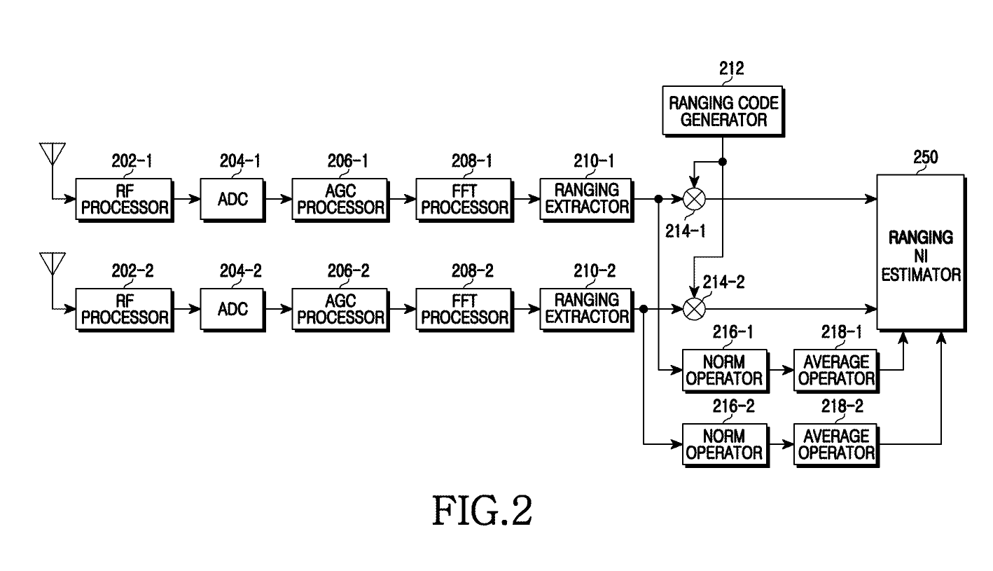

FIG. 2 is a block diagram of a base station in a broadband wireless communication system according to an exemplary embodiment of the present invention.

Referring to FIG. 2, the base station includes two Radio Frequency (RF) processors 202-1 and 202-2, two Analog-to-Digital Converters (ADCs) 204-1 and 204-2, two Automatic Gain Control (AGC) processors 206-1 and 206-2, two Fast Fourier Transform (FFT) processors 208-1 and 208-2, two ranging extractors 210-1 and 210-2, a ranging code generator 212, two multipliers 214-1 and 214-2, two norm operators 216-1 and 216-2, two average operators 218-1 and 218-2, and a ranging NI estimator 250.

Each of the RF processors 202-1 and 202-2 downconverts an RF signal received through a corresponding antenna into an Intermediate Frequency (IF) analog signal. Each of the ADCs 204-1 and 204-2 converts the IF analog signal into a digital signal. Each of the AGC processors 206-1 and 206-2 controls the digital signal to a certain size. Each of the FFT processors 208-1 and 208-2 converts a received signal through an FFT operation into per-subcarrier signals. Each of the ranging extractors 210-1 and 210-2 extracts signals mapped to L ranging subcarriers from the per-subcarrier signals. Hereinafter, for the convenience of description, ‘signal mapped to ranging subcarriers’ will be referred to as ‘ranging subcarrier signal’. That is, each of the ranging extractors 210-1 and 210-2 extracts a ranging signal including interference and noise from a received signal. The extracted ranging subcarrier signal is provided to the multipliers 214-1 and 214-2 and the norm operators 216-1 and 216-2.

The ranging code generator 212 generates and outputs ranging codes transmittable from user terminals. The respective multipliers 214-1 and 214-2 multiply the ranging subcarrier signal provided from the ranging extractors 210-1 and 210-2 respectively by the ranging codes provided from the ranging code generator 212. Herein, the ranging code includes L elements, and the L elements are multiplied respectively by the L elements of the ranging subcarrier signal on a one-to-one basis. Thus, an operation of each of the multipliers 214-1 and 214-2 is the same as a correlation operation, and the number of result values calculated is the same as the number of the ranging codes output from the ranging code generator 212.

Each of the norm operators 216-1 and 216-2 performs a norm operation to calculate the power values of the ranging subcarrier signal. The norm operation refers to an operation of the square of magnitude.

Each of the average operators 218-1 and 218-2 averages the power values obtained through the norm operation, by the subcarrier. For example, each of the average operators 218-1 and 218-2 performs an operation expressed as Equation (1):

$${P}_{received} = \frac{1}{L} {\sum }_{i = 1}^{L} {\vert {R}_{i} \vert}^{2} \approx {\vert H \vert}^{2} + {\vert U \vert}^{2} , {R}_{i} = {H}_{i} {C}_{i} + {U}_{i} \qquad ( 1 )$$

where P_{received} denotes the average power of a received ranging subcarrier signal, i.e., the output of each of the average operators 218-1 and 218-2, L denotes the number of ranging subcarriers, Rᵢ denotes the i^{th} subcarrier signal of a received ranging subcarrier signal, Hᵢ denotes a channel response component of the i^{th} subcarrier, Cᵢ denotes the i^{th} subcarrier signal of a transmitted ranging code, Uᵢ denotes an interference/noise component of the i^{th} subcarrier, |H|² denotes the average signal power of all the subcarriers, and |U|² denotes the interference/noise power of all the subcarriers.

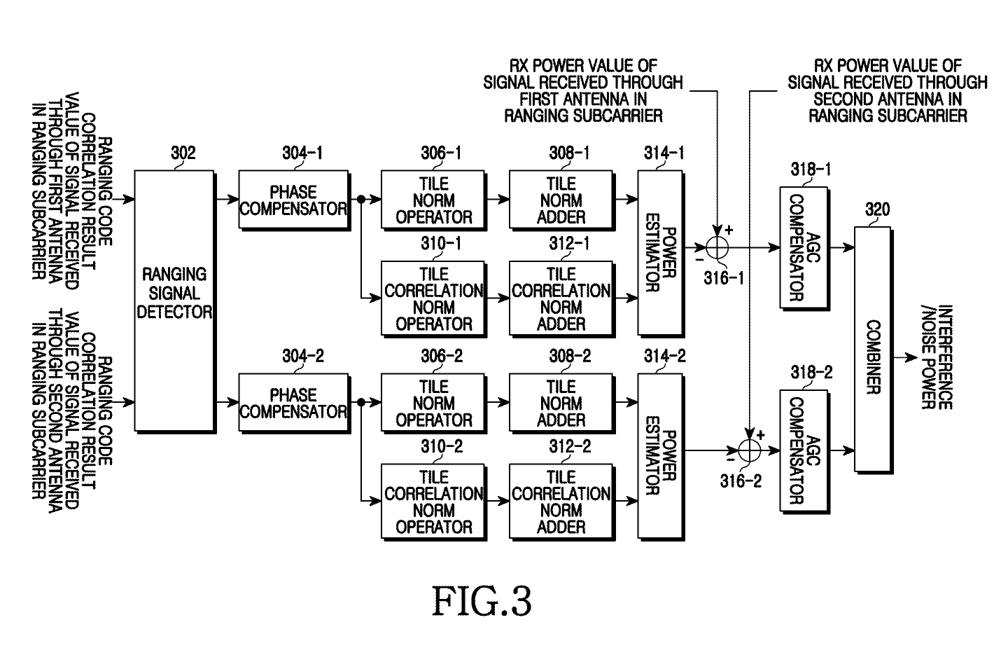

FIG. 3 is a block diagram of a ranging NI estimator in a broadband wireless communication system according to an exemplary embodiment of the present invention.

Referring to FIG. 3, the ranging NI estimator includes a ranging signal detector 302, two phase compensators 304-1 and 304-2, two tile norm operators 306-1 and 306-2, two tile norm adders 308-1 and 308-2, two tile correlation norm operators 310-1 and 310-2, two tile correlation norm adders 312-1 and 312-2, two power estimators 314-1 and 314-2, two adder/subtractors 316-1 and 316-2, two AGC compensators 318-1 and 318-2, and a combiner 320.

The ranging signal detector 302 detects a desired RX ranging signal by receiving the products of the ranging codes and the ranging subcarrier signal from the multipliers 214-1 and 214-2. The ranging signal detector 302 may detect a plurality of desired RX ranging signals simultaneously, and outputs the detected ranging signals to the phase compensators 304-1 and 304-2. The ranging signal detection may be performed in a variety of known methods. For example, the output of the ranging signal detector 302 may be expressed as Equation (2):

Z_{m,k}ⁿC_{m,k}ⁿ×R_{m,k} (2)

where Z_{m,k}ⁿ denotes the k^{th} subcarrier component of the m^{th} tile in the product of the n^{th} ranging code and a ranging subcarrier signal, C_{m,k}ⁿ denotes the k^{th} subcarrier component of the m^{th} tile in the n^{th} ranging code, and R_{m,k} denotes the k^{th} subcarrier signal of the m^{th} tile.

Each of the phase compensators 304-1 and 304-2 compensates a phase distortion of the ranging signal due to a timing offset.

Each of the tile norm operators 306-1 and 306-2 calculates the sum for each tile of ranging signal norms of each subcarrier. That is, each of the tile norm operators 306-1 and 306-2 calculates norms of signals for each subcarrier and sums the calculated norms for each tile. For example, the output of each of the tile norm operators 306-1 and 306-2 may be expressed as Equation (3):

$${P}_{sub , m} = \frac{1}{4} {\sum }_{k = 1}^{4} {\vert {Z}_{m , k}^{n} \vert}^{2} \qquad ( 3 )$$

where P_{sub,m} denotes the sum of the ranging signal norms of each subcarrier included in the m^{th} tile, and Z_{m,k}ⁿ denotes the k^{th} subcarrier signal of the m^{th} tile in the ranging signal detected for the n^{th} desired RX signal.

Each of the tile norm adders 308-1 and 308-2 adds the sums for the respective tiles of the signal norms. For example, the output of each of the tile norm adders 308-1 and 308-2 may be expressed as Equation (4):

$$\begin{matrix}{P}_{sub} = \frac{1}{4} {\sum }_{m = 1}^{36} {\sum }_{k = 1}^{4} {\vert {Z}_{m , k}^{n} \vert}^{2} \\ \approx {\sum }_{m = 1}^{36} {\vert {H}_{m}^{n} \vert}^{2} + {\sum }_{m = 1}^{36} {\vert {U}_{m} \vert}^{2} \\ = 36 {\vert {H}^{n} \vert}^{2} + 36 {\vert U \vert}^{2}\end{matrix} \qquad ( 4 )$$

where P_{sub} denotes the sum of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

Each of the tile correlation norm operators 310-1 and 310-2 calculates the norm for the sum of signals for each subcarrier in the tile. That is, each of the tile correlation norm operators 310-1 and 310-2 sums signals for each subcarrier on a tile-by-tile basis, and calculates the norm of each of the signals summed on a tile-by-tile basis. For example, the output of each of the tile correlation norm operators 310-1 and 310-2 may be expressed as Equation (5):

$${P}_{tile , m} = \frac{1}{16} {\vert {\sum }_{k = 1}^{4} {Z}_{m , k}^{n} \vert}^{2} \qquad ( 5 )$$

where P_{tile,m} denotes the norm of the sum of the ranging signals detected in the m^{th} tile, and Z_{m,k}ⁿ denotes the k^{th} subcarrier signal of the m^{th} tile in the ranging signal detected for the n^{th} desired RX signal.

Each of the tile correlation norm adders 312-1 and 312-2 adds all the norms for the sum of signals for each subcarrier in the tile. For example, the output of each of the tile correlation norm adders 312-1 and 312-2 may be expressed as Equation (6):

$$\begin{matrix}{P}_{tile} = \frac{1}{16} {\sum }_{m = 1}^{36} {\vert {\sum }_{k = 1}^{4} {Z}_{m , k}^{n} \vert}^{2} \\ \approx {\sum }_{m = 1}^{36} {\vert {H}_{m}^{n} \vert}^{2} + \frac{1}{4} {\sum }_{m = 1}^{36} {\vert {U}_{m} \vert}^{2} \\ = 36 {\vert {H}^{n} \vert}^{2} + 9 {\vert U \vert}^{2}\end{matrix} \qquad ( 6 )$$

where Pₜᵢₗₑ denotes the sum of the norms of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

Each of the power estimators 314-1 and 314-2 estimates the signal power of a detected ranging signal by using the sum for each tile of signal norms and the sum of the norms for the sum of signals for each subcarrier in the tile. For example, based on the result values expressed as Equations (4) and (6), each of the power estimators 314-1 and 314-2 may estimate the signal power of a detected ranging signal through an operation expressed as Equation (7):

$${P}_{signal power} = {\vert {H}^{n} \vert}^{2} = \frac{1}{27} ( {P}_{tile} - \frac{{P}_{sub}}{4} ) \qquad ( 7 )$$

where P_{signal power} denotes the signal power of the detected ranging signal, |Hⁿ|² denotes the average signal power of all the tiles, P_{sub} denotes the sum of the sums for the respective tiles, and Pₜᵢₗₑ denotes the sum of the norms of the sums for the respective tiles.

Each of the adder/subtractors 316-1 and 316-2 subtracts the signal power of a detected ranging signal from the RX power value of a ranging subcarrier signal. For example, based on the result values expressed as Equations (1) and (7), each of the adder/subtractors 316-1 and 316-2 may perform an operation expressed as Equation (8):

$$\begin{matrix}{P}_{received} - {P}_{signal power} = ( {\vert H \vert}^{2} + {\vert U \vert}^{2} ) - {\vert {H}^{n} \vert}^{2} \\ = ( {\vert H \vert}^{2} - {\vert {H}^{n} \vert}^{2} ) + {\vert U \vert}^{2}\end{matrix} \qquad ( 8 )$$

where P_{received} denotes the RX power of a ranging subcarrier signal, P_{signal power} denotes the signal power of a detected ranging signal, |Hⁿ|² denotes the average signal power of all the tiles, |H|² denotes the average signal power of all the subcarriers, and |U|² denotes the average interference/noise power of all the tiles.

Herein, if a plurality of ranging signals are detected by the ranging signal detector 302, the estimation of the signal power of a detected ranging signal through the tile norm operators 306-1 and 306-2, the tile norm adders 308-1 and 308-2, the tile correlation norm operators 310-1 and 310-2, the tile correlation norm adders 312-1 and 312-2, and the power estimators 314-1 and 314-2 is repeated for each ranging signal and each of the adder/subtractors 316-1 and 316-2 subtracts the signal power of all the detected ranging signals from the RX power of the ranging subcarrier. For example, the output of each of the adder/subtractors 316-1 and 316-2 after completion of the repetition of signal power estimation for all the ranging signals is expressed as Equation (9):

$$\begin{matrix}{P}_{received} - {P}_{signal power} = ( {\vert H \vert}^{2} + {\vert U \vert}^{2} ) - {\sum }_{n = 1}^{N} {\vert {H}^{n} \vert}^{2} \\ = ( {\vert H \vert}^{2} - {\sum }_{n = 1}^{N} {\vert {H}^{n} \vert}^{2} ) + {\vert U \vert}^{2} \\ \approx {\vert U \vert}^{2}\end{matrix} \qquad ( 9 )$$

where P_{received} denotes the RX power of a ranging subcarrier signal, P_{signal power} denotes the signal power of a detected ranging signal, |H|² denotes the average signal power of all the subcarriers, N denotes the number of detected ranging signals, |Hⁿ|² denotes the average signal power of all the tiles, and |U|² denotes the average interference/noise power of all the tiles.

Each of the AGC compensators 318-1 and 318-2 compensates a signal gain controlled by each of the AGC processors 206-1 and 206-2.

The combiner 320 combines the noise and interference values of the ranging channel measured for the respective antennas, thereby determining the final noise and interference. For example, the combiner 320 may sum the noise and interference values of the ranging channel measured for the respective antennas, or may select one of the noise and interference values of the ranging channel measured for the respective antennas. In other exemplary embodiments, the combiner 320 may determine the final noise and interference using other various methods.

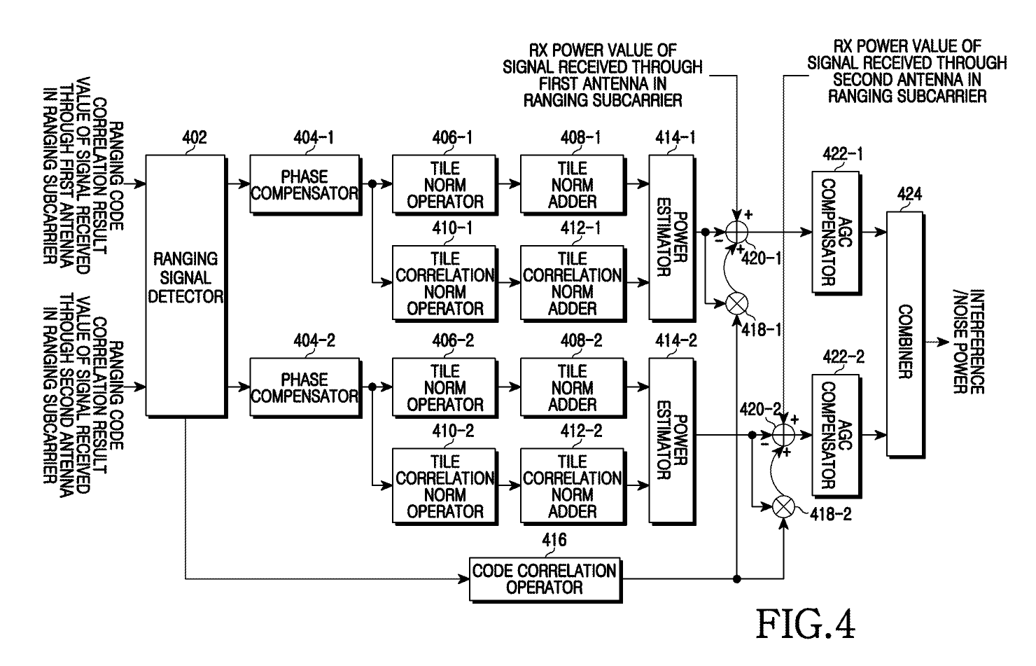

FIG. 4 is a block diagram of a ranging NI estimator in a broadband wireless communication system according to another embodiment of the present invention.

Referring to FIG. 4, the ranging NI estimator includes a ranging signal detector 402, two phase compensators 404-1 and 404-2, two tile norm operators 406-1 and 406-2, two tile norm adders 408-1 and 408-2, two tile correlation norm operators 410-1 and 410-2, two tile correlation norm adders 412-1 and 412-2, two power estimators 414-1 and 414-2, a code correlation operator 416, two post-multiplication adders 418-1 and 418-2, two adder/subtractors 420-1 and 420-2, two AGC compensators 422-1 and 422-2, and a combiner 424.

The ranging signal detector 402 detects a desired RX ranging signal by receiving the products of the ranging codes and the ranging subcarrier signal from the multipliers 214-1 and 214-2. The ranging signal detector 402 may detect a plurality of desired RX ranging signals simultaneously, and outputs the detected ranging signals to the phase compensators 404-1 and 404-2. The ranging signal detector 402 also outputs the detected ranging signals to the code correlation operator 416. The ranging signal detection may be performed in a variety of known methods. For example, the output of the ranging signal detector 402 may be expressed as Equation (2).

Each of the phase compensators 404-1 and 404-2 compensates a phase distortion of the ranging signal due to a timing offset.

Each of the tile norm operators 406-1 and 406-2 calculates the sum for each tile of signal norms for each subcarrier. That is, each of the tile norm operators 406-1 and 406-2 calculates norms of signals for each subcarrier and sums the calculated norms for each tile. For example, the output of each of the tile norm operators 406-1 and 406-2 may be expressed as Equation (3).

Each of the tile norm adders 408-1 and 408-2 adds the sums for the respective tiles of the signal norms. For example, the output of each of the tile norm adders 408-1 and 408-2 may be expressed as Equation (4).

Each of the tile correlation norm operators 410-1 and 410-2 calculates the norm for the sum of signals for each subcarrier in the tile. That is, each of the tile correlation norm operators 410-1 and 410-2 sums signals for each subcarrier on a tile-by-tile basis, and calculates the norm of each of the signals summed on a tile-by-tile basis. For example, the output of each of the tile correlation norm operators 410-1 and 410-2 is expressed as Equation (5).

Each of the tile correlation norm adders 412-1 and 412-2 adds all the norms for the sum of signals for each subcarrier in the tile. For example, the output of each of the tile correlation norm adders 412-1 and 412-2 may be expressed as Equation (6).

Each of the power estimators 414-1 and 414-2 estimates the signal power of a detected ranging signal by using the sum for each tile of signal norms and the sum of the norms for the sum of signals for each subcarrier in the tile. For example, based on the result values expressed as Equations (4) and (6), each of the power estimators 414-1 and 414-2 may estimate the signal power of a detected ranging signal through an operation expressed as Equation (7).

The code correlation operator 416 operates if a plurality of ranging signals are detected by the ranging signal detector 402. In this case, the code correlation operator 416 calculates all the correlation values between the detected ranging signals. That is, the code correlation operator 416 calculates the correlation values between one of the detected ranging signals and each of the other ranging signals, and also calculates the correlation values for each of the other ranging signals.

Each of the post-multiplication adders 418-1 and 418-2 multiplies the correlation values between the ranging signals received from the code correlation operator 416 and the power value of the ranging signal corresponding to each of the correlation values. For example, if three ranging signals A, B and C are detected, the post-multiplication adder 418-1/418-2 adds the product of the square root of the power of the ranging signal A, the square root of the power of the ranging signal B and the correlation values of the ranging signals A and B, and the product of the square root of the power of the ranging signal A, the square root of the power of the ranging signal C and the correlation values of the ranging signals A and C. Also, the post-multiplication adder 418-1/418-2 adds the product of the square root of the power of the ranging signal B, the square root of the power of the ranging signal A and the correlation values of the ranging signals B and A, and the product of the square root of the power of the ranging signal B, the square root of the power of the ranging signal C and the correlation values of the ranging signals B and C. Also, the post-multiplication adder 418-1/418-2 adds the product of the square root of the power of the ranging signal C, the square root of the power of the ranging signal A and the correlation values of the ranging signals C and A, and the square root of the power of the ranging signal C, the square root of the power of the ranging signal B and the correlation values of the ranging signals C and B. That is, each of the post-multiplication adders 418-1 and 418-2 generates a correlation distortion compensation value for compensating a power component distorted due to the correlation value between the ranging codes. For example, the output of each of the post-multiplication adders 418-1 and 418-2 may be expressed as Equation (10):

$${Φ}^{n} = {\sum }_{k = 1 , k \neq n}^{N} \{ ( \frac{1}{L} {\sum }_{i = 1}^{L} {C}_{i}^{{n}^{*}} {C}_{i}^{k} ) \vert {H}^{n} \vert \vert {H}^{k} \vert \} \qquad ( 10 )$$

where Φⁿ denotes the correlation value between the n^{th} ranging code and the other ranging codes, N denotes the number of detected ranging signals, Cᵢⁿ denotes the i^{th} component in the n^{th} ranging code, L denotes a ranging code length, and |Hⁿ| denotes the signal power of the n^{th} ranging code.

Each of the adder/subtractors 420-1 and 420-2 subtracts the signal power of a detected ranging signal from the RX power of a ranging subcarrier, and adds the correlation distortion compensation value. For example, based on the result values expressed as Equations (1) and (10), each of the adder/subtractors 420-1 and 420-2 may perform an operation expressed as Equation (11):

$${P}_{received} - {P}_{signal power} + {P}_{correlation} = ( {\vert H \vert}^{2} + {\vert U \vert}^{2} ) - {\sum }_{n = 1}^{N} {\vert {H}^{n} \vert}^{2} + {\sum }_{n = 1}^{N} {Φ}^{n} \approx {\vert U \vert}^{2} \qquad ( 11 )$$

where P_{received} denotes the RX power of a ranging subcarrier signal, P_{signal power} denotes the signal power of a detected ranging signal, P_{correlation} denotes the compensation value of the distortion due to the correlation between ranging codes, |H|² denotes the average signal power of all the subcarriers, N denotes the number of detected ranging signals, |Hⁿ|² denotes the average signal power of all the tiles, Φⁿ denotes the correlation value between the n^{th} ranging code and the other ranging codes, and |U|² denotes the average interference/noise power of all the tiles.

Herein, if a plurality of ranging signals are detected by the ranging signal detector 402, the estimation of the signal power of a detected ranging signal through the tile norm operators 406-1 and 406-2, the tile norm adders 408-1 and 408-2, the tile correlation norm operators 410-1 and 410-2, the tile correlation norm adders 412-1 and 412-2, and the power estimators 414-1 and 414-2 is repeated for each ranging signal and each of the adder/subtractors 420-1 and 420-2 subtracts the signal power of all the detected ranging signals from the RX power of the ranging subcarrier.

Each of the AGC compensators 422-1 and 422-2 compensates a signal gain controlled by each of the AGC processors 206-1 and 206-2.

The combiner 424 combines the noise and interference values of the ranging channel measured for the respective antennas, thereby determining the final noise and interference. For example, the combiner 424 sums the noise and interference values of the ranging channel measured for the respective antennas, or selects one of the noise and interference values of the ranging channel measured for the respective antennas. In other exemplary embodiments, the combiner 424 may determine the final noise and interference using other various methods.

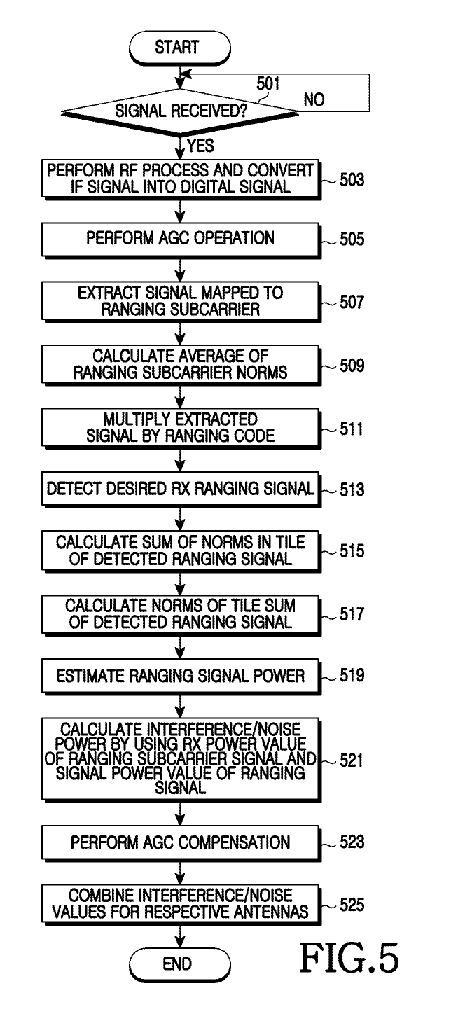

FIG. 5 is a flow diagram illustrating a process for estimating a UL NI of a base station in a broadband wireless communication system according to an exemplary embodiment of the present invention.

Referring to FIG. 5, in step 501, the base station determines whether an uplink signal is received.

If the uplink signal is received (in step 501), the process proceeds to step 503. In step 503, the base station downconverts the received signal into an IF signal and converts the IF signal into a digital signal.

In step 505, the base station performs an AGC operation to control the digital signal to a certain size.

In step 507, the base station performs an FFT operation to restore signals for respective subcarriers, and then extracts signals mapped to a ranging subcarrier. For example, the ranging subcarrier is a subcarrier that is located as illustrated in FIG. 1.

In step 509, the base station calculates the average of ranging subcarrier norms. That is, the base station performs a norm operation on the ranging subcarrier signal on a subcarrier-by-subcarrier basis, and averages the respective norm operation result values. That is, the base station calculates the RX power value of a ranging subcarrier signal. For example, the average of the ranging subcarrier norms may be expressed as Equation (1).

In step 511, the base station multiplies ranging codes by a ranging subcarrier signal extracted from the ranging subcarrier. Herein, the ranging code includes L elements, and the L elements are multiplied respectively by the L ranging subcarriers on a one-to-one basis. Thus, an operation of step 511 is the same as a correlation operation, and as many correlation result values as the number of ranging codes are output.

In step 513, the base station detects a desired RX ranging signal by using the correlation result value between the ranging subcarrier signal and the ranging codes. Herein, a plurality of ranging signals may be detected simultaneously. The ranging signal detection may be performed in a variety of known methods.

In step 515, the base station calculates the sum of norms in the tile of the ranging signal. That is, the base station calculates norms of signals for each subcarrier and sums the calculated norms for each tile. Thereafter, the base station adds all the sums for the respective tiles. For example, the base station may perform operations expressed as Equations (3) and (4).

In step 517, the base station calculates norms of the tile sum of the ranging signal. That is, the base station sums signals for each subcarrier on a tile-by-tile basis, and calculates the norm of each of the signals summed on a tile-by-tile basis. For example, the base station may perform operations expressed as Equations (5) and (6).

In step 519, the base station estimates the signal power of a detected ranging signal by using the total sum for each tile of ranging signal norms and the total sum of the norms for the sum of signals for each subcarrier in the tile. For example, the base station may estimate the signal power of a detected ranging signal as Equation (7).

In step 521, the base station calculates the interference/noise power by using the RX power value of the ranging subcarrier signal calculated in step 509 and the signal power value of the detected ranging signal calculated in step 519. That is, the base station calculates the interference/noise power of a ranging channel by subtracting the signal power value of the detected ranging signal from the average value of the ranting subcarrier norms.

In step 523, the base station compensates a signal gain controlled due to the AGC operation in step 505.

In step 525, the base station combines the interference and noise values calculated for the respective antennas, thereby determining the final noise and interference. For example, the base station may sum the noise and interference values of the ranging channel measured for the respective antennas, or may select one of the noise and interference values of the ranging channel measured for the respective antennas. In other exemplary embodiments, the base station may determine the final noise and interference using other various methods.

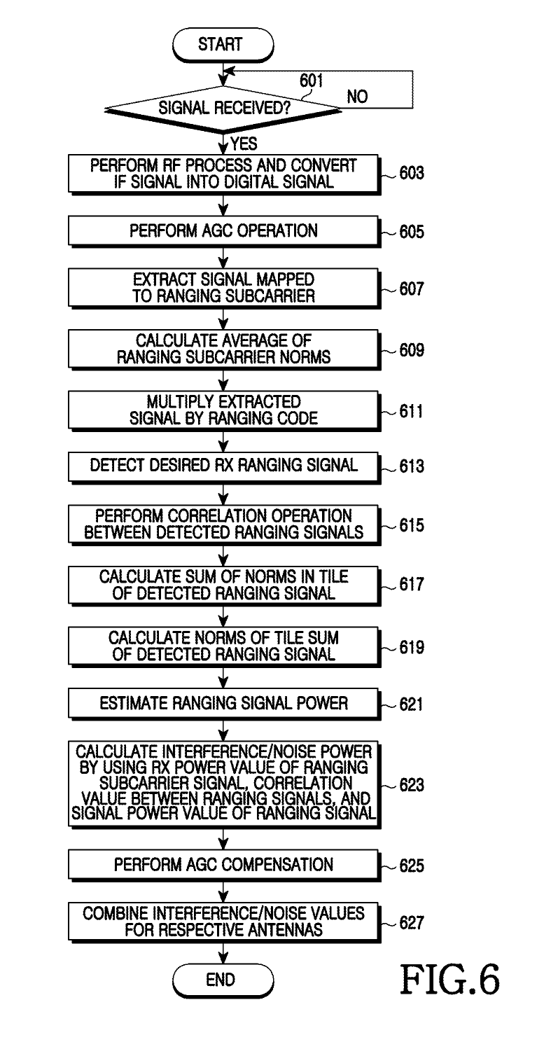

FIG. 6 is a flow diagram illustrating a process for estimating an UL NI of a base station in a broadband wireless communication system according to another embodiment of the present invention.

Referring to FIG. 6, in step 601, the base station determines whether an uplink signal is received.

If the uplink signal is received (in step 601), the process proceeds to step 603. In step 603, the base station downconverts the received signal into an IF signal and converts the IF signal into a digital signal.

In step 605, the base station performs an AGC operation to control the digital signal to a certain size.

In step 607, the base station performs an FFT operation to restore signals for respective subcarriers, and then extracts signals mapped to a ranging subcarrier. For example, the ranging subcarrier may be a subcarrier that is located as illustrated in FIG. 1.

In step 609, the base station calculates the average of ranging subcarrier norms. More specifically, the base station performs a norm operation on the ranging subcarrier signal on a subcarrier-by-subcarrier basis, and averages the respective norm operation result values. That is, the base station calculates the RX power value of a ranging subcarrier signal. For example, the average of the ranging subcarrier norms may be expressed as Equation (1).

In step 611, the base station multiplies ranging codes by a ranging subcarrier signal extracted from the ranging subcarrier. Herein, the ranging code includes L elements, and the L elements are multiplied respectively by the L ranging subcarriers on a one-to-one basis. Thus, an operation of step 611 is substantially the same as a correlation operation, and as many correlation result values as the number of ranging codes are output.

In step 613, the base station detects a desired RX ranging signal by using the correlation result value between the ranging subcarrier signal and the ranging codes. Herein, a plurality of ranging signals may be detected simultaneously. The ranging signal detection may be performed in a variety of known methods.

In step 615, the base station calculates all the correlation values between the detected ranging signals. That is, the base station calculates the correlation values between one of the detected ranging signals and the other ranging signals, and also calculates the correlation values for the other ranging signals. If only one ranging signal is detected in step 613, step 615 is omitted.

In step 617, the base station calculates the sum of norms in the tile of the ranging signal. That is, the base station calculates norms of signals for each subcarrier and sums the calculated norms for each tile. Thereafter, the base station adds all the sums for the respective tiles. For example, the base station may perform operations expressed as Equations (3) and (4).

In step 619, the base station calculates norms of the tile sum of the ranging signal. That is, the base station sums signals for each subcarrier on a tile-by-tile basis, and calculates the norm of each of the signals summed on a tile-by-tile basis. For example, the base station may perform operations expressed as Equations (5) and (6).

In step 621, the base station estimates the signal power of a detected ranging signal by using the total sum for each tile of ranging signal norms and the total sum of the norms for the sum of signals for each subcarrier in the tile. For example, the base station estimates the signal power of a detected ranging signal as Equation (7).

In step 623, the base station calculates the interference/noise power by using the RX power value of the ranging subcarrier signal calculated in step 609, the correlation values between the detected ranging signals calculated in step 617, and the signal power value of the detected ranging signal calculated in step 621. That is, the base station calculates the interference/noise power of a ranging channel by subtracting the signal power value of the detected ranging signal from the average value of the ranging subcarrier norms and adding the signal power value of the ranging signal and the product of the correlation values between the ranging signals.

In step 625, the base station compensates a signal gain controlled due to the AGC operation in step 605.

In step 627, the base station combines the interference and noise values calculated for the respective antennas, thereby determining the final noise and interference. For example, the base station may sum the noise and interference values of the ranging channel measured for the respective antennas, or may select one of the noise and interference values of the ranging channel measured for the respective antennas. In other exemplary embodiments, the base station may determine the final noise and interference using other various methods.

As described above, exemplary embodiments of the present invention accurately estimate the UL NI by using the correlation between the ranging signals. Thus, exemplary embodiments of the present invention can prevent the system performance degradation due to a power control failure.

Although the invention has been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An apparatus for a base station in a wireless communication system, the apparatus comprising:
an operator for calculating the receive (RX) power of a ranging subcarrier signal received through ranging subcarriers;
an estimator for estimating the signal power of a detected ranging signal; and
an adder/subtractor for calculating the noise/interference power of a ranging channel by subtracting the signal power of the detected ranging signal from the RX power of the ranging subcarrier signal.

2. The apparatus of claim 1, wherein the operator calculates the RX power of the ranging subcarrier signal by calculating an average of the subcarrier-by-subcarrier norms of the ranging subcarrier signal.

3. The apparatus of claim 1, further comprising:
a tile norm operator for calculating the tile-by-tile sum of the subcarrier-by-subcarrier norm of the detected ranging signal;
a tile norm adder for summing tile-by-tile sums and providing a sum of the tile-by-tile sums to the estimator;
a tile correlation norm operator for calculating the norm of the tile-by-tile sum of the detected ranging signal; and
a tile correlation norm adder for summing the norms of the tile-by-tile sum and providing the sum of the norms the tile-by-tile sum to the estimator.

4. The apparatus of claim 3, wherein the tile norm adder outputs a value expressed by the following equation:
$$\begin{matrix}{P}_{sub} = \frac{1}{4} {\sum }_{m = 1}^{36} {\sum }_{k = 1}^{4} {\vert {Z}_{m , k}^{n} \vert}^{2} \\ \approx {\sum }_{m = 1}^{36} {\vert {H}_{m}^{n} \vert}^{2} + {\sum }_{m = 1}^{36} {\vert {U}_{m} \vert}^{2} \\ = 36 {\vert {H}^{n} \vert}^{2} + 36 {\vert U \vert}^{2}\end{matrix}$$
where P_{sub} denotes the sum of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

5. The apparatus of claim 3, wherein the tile correlation norm adder outputs a value expressed by the following equation:
$$\begin{matrix}{P}_{tile} = \frac{1}{16} {\sum }_{m = 1}^{36} {\vert {\sum }_{k = 1}^{4} {Z}_{m , k}^{n} \vert}^{2} \\ \approx {\sum }_{m = 1}^{36} {\vert {H}_{m}^{n} \vert}^{2} + \frac{1}{4} {\sum }_{m = 1}^{36} {\vert {U}_{m} \vert}^{2} \\ = 36 {\vert {H}^{n} \vert}^{2} + 9 {\vert U \vert}^{2}\end{matrix}$$
where Pₜᵢₗₑ denotes the sum of the norms of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

6. The apparatus of claim 3, wherein the estimator estimates the signal power of the detected ranging signal by using the sum of the tile-by-tile sums and the sum of the norms of the tile-by-tile sum.

7. The apparatus of claim 6, wherein the estimator estimates the signal power of the detected ranging signal using the following equation:
$${P}_{signal power} = {\vert {H}^{n} \vert}^{2} = \frac{1}{27} ( {P}_{tile} - \frac{{P}_{sub}}{4} )$$
where P_{signal power} denotes the signal power of the detected ranging signal, |Hⁿ|² denotes the average signal power of all the tiles, P_{sub} denotes the sum of the sums for the respective tiles, and Pₜᵢₗₑ denotes the sum of the norms of the sums for the respective tiles.

8. The apparatus of claim 1, further comprising:
a correlation operator for calculating, if a plurality of ranging codes are detected, correlation values between the detected ranging codes; and
a multiplier for calculating a correlation distortion compensation value by multiplying each of the ranging codes by a corresponding correlation value,
wherein the adder/subtractor calculates the noise/interference power of a ranging channel by subtracting the signal power of each of the detected ranging signals from the RX power of the ranging subcarrier signal and adding the correlation distortion compensation value.

9. The apparatus of claim 8, wherein the multiplier calculates the correlation distortion compensation value using the following equation:
$${Φ}^{n} = {\sum }_{k = 1 , k \neq n}^{N} \{ ( \frac{1}{L} {\sum }_{i = 1}^{L} {C}_{i}^{{n}^{*}} {C}_{i}^{k} ) \vert {H}^{n} \vert \vert {H}^{k} \vert \}$$
where Φⁿ denotes the correlation value between the n^{th} ranging code and the other ranging codes, N denotes the number of detected ranging signals, Cᵢⁿ denotes the i^{th} component in the n^{th} ranging code, L denotes a ranging code length, and |Hⁿ| denotes the signal power of the n^{th} ranging code.

10. The apparatus of claim 1, further comprising a compensator for compensating a signal gain controlled due to Automatic Gain Control (AGC) from the output value of the adder/subtractor.

11. The apparatus of claim 1, further comprising a combiner for combining a plurality of noise/interference power values calculated for a plurality of antennas.

12. The apparatus of claim 11, wherein the combiner combines the noise/interference power values by at least one of summing the noise/interference power values and selecting one of the noise/interference power values.

13. A method for estimating a ranging channel noise/interference power value of a base station in a wireless communication system, the method comprising:
calculating the receive (RX) power of a ranging subcarrier signal received through ranging subcarriers;
estimating the signal power of a detected ranging signal; and
calculating the noise/interference power of a ranging channel by subtracting the signal power of the detected ranging signal from the RX power of the ranging subcarrier signal.

14. The method of claim 13, wherein the calculating of the RX power of the ranging subcarrier signal comprises averaging of the subcarrier-by-subcarrier norms of the ranging subcarrier signal.

15. The method of claim 13, wherein the estimating of the signal power of the detected ranging signal comprises:
calculating the tile-by-tile sum of the subcarrier-by-subcarrier norm of the detected ranging signal;
summing the tile-by-tile sums;
calculating the norm of the tile-by-tile sum of the detected ranging signal; and
summing the norms of the tile-by-tile sum.

16. The method of claim 15, wherein the summing of the tile-by-tile sums comprises using the following equation:
$$\begin{matrix}{P}_{sub} = \frac{1}{4} {\sum }_{m = 1}^{36} {\sum }_{k = 1}^{4} {\vert {Z}_{m , k}^{n} \vert}^{2} \\ \approx {\sum }_{m = 1}^{36} {\vert {H}_{m}^{n} \vert}^{2} + {\sum }_{m = 1}^{36} {\vert {U}_{m} \vert}^{2} \\ = 36 {\vert {H}^{n} \vert}^{2} + 36 {\vert U \vert}^{2}\end{matrix}$$
where P_{sub} denotes the sum of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

17. The method of claim 15, wherein the summing of the norms of the tile-by-tile sum comprises using the following equation:
$$\begin{matrix}{P}_{tile} = \frac{1}{16} {\sum }_{m = 1}^{36} {\vert {\sum }_{k = 1}^{4} {Z}_{m , k}^{n} \vert}^{2} \\ \approx {\sum }_{m = 1}^{36} {\vert {H}_{m}^{n} \vert}^{2} + \frac{1}{4} {\sum }_{m = 1}^{36} {\vert {U}_{m} \vert}^{2} \\ = 36 {\vert {H}^{n} \vert}^{2} + 9 {\vert U \vert}^{2}\end{matrix}$$
where Pₜᵢₗₑ denotes the sum of the norms of the sums for the respective tiles, Z_{m,k}ⁿ denotes the k^{th} subcarrier signal of the m^{th} tile in the ranging signal detected for the n^{th} desired RX signal, |Hₘⁿ|² denotes the post-channel signal power of a signal in the m^{th} tile, |Uₘ|² denotes the average interference/noise power of a signal in the m^{th} tile, |Hⁿ|² denotes the average signal power of all the tiles, and |U|² denotes the average interference/noise power of all the tiles.

18. The method of claim 15, wherein the estimating of the signal power of the detected ranging signal comprises using the sum of the tile-by-tile sums and the sum of the norms of the tile-by-tile sum.

19. The method of claim 18, wherein the estimating of the signal power of the detected ranging signal comprises using the following equation:
$${P}_{signal power} = {\vert {H}^{n} \vert}^{2} = \frac{1}{27} ( {P}_{tile} - \frac{{P}_{sub}}{4} )$$
where P_{signal power} denotes the signal power of the detected ranging signal, |Hⁿ|² denotes the average signal power of all the tiles, P_{sub} denotes the sum of the sums for the respective tiles, and Pₜᵢₗₑ denotes the sum of the norms of the sums for the respective tiles.

20. The method of claim 13, further comprising:
calculating, if a plurality of ranging codes are detected, correlation values between the detected ranging codes;
calculating a correlation distortion compensation value by multiplying each of the ranging codes by a corresponding correlation value; and
calculating the noise/interference power of a ranging channel by subtracting the signal power of each of the detected ranging signals from the RX power of the ranging subcarrier signal and adding the correlation distortion compensation value.

21. The method of claim 20, wherein the calculating of the correlation distortion compensation value comprises using the following equation:
$${Φ}^{n} = {\sum }_{k = 1 , k \neq n}^{N} \{ ( \frac{1}{L} {\sum }_{i = 1}^{L} {C}_{i}^{{n}^{*}} {C}_{i}^{k} ) \vert {H}^{n} \vert \vert {H}^{k} \vert \}$$
where Φⁿ denotes the correlation value between the n^{th} ranging code and the other ranging codes, N denotes the number of detected ranging signals, Cᵢⁿ denotes the i^{th} component in the n^{th} ranging code, L denotes a ranging code length, and |Hⁿ| denotes the signal power of the n^{th} ranging code.

22. The method of claim 13, further comprising compensating a signal gain controlled due to Automatic Gain Control (AGC) from the noise/interference value of the ranging channel.

23. The method of claim 13, further comprising combining a plurality of noise/interference power values calculated for a plurality of antennas.

24. The method of claim 23, wherein the combining of the plurality of noise/interference power values calculated for the antennas comprises summing the noise/interference power values or by selecting one of the noise/interference power values.
